(19) United States
(12) Patent Application Publication
(10) Pub. No.: US 2026/0107918 A1
(43) Pub. Date: Apr. 23, 2026

(54) PORTABLE COOLER FOR PET FOOD, WATER, AND SUPPLIES

(71) Applicant: Wendy King, Cape Coral, FL (US)

(72) Inventor: Wendy King, Cape Coral, FL (US)

(21) Appl. No.: 18/922,312

(22) Filed: Oct. 21, 2024

(51) Int. Cl. A01K 5/01; B65D 25/28; B65D 43/16; B65D 51/28; B65D 81/38

(52) U.S. Cl. CPC A01K 5/0114; B65D 25/2867; B65D 43/163; B65D 51/28; B65D 81/3813; B65D 2525/28

(57) ABSTRACT

A portable cooler for pet supplies is disclosed including a cooler having an insulated housing constructed having an interior reservoir to retain water. A top is removably connected to the insulated housing and constructed as a container to store one or more pet supplies. The portable cooler allows pet owners to easily transport, access and provide water and food to their pets.

### TECHNICAL FIELD

The embodiments disclosed herein generally relate to portable coolers and more specifically to portable coolers designed to transport pet food, water, and other items.

### BACKGROUND

Animals are often kept for a person's company, entertainment, or for working purposes and accompany individuals in the home as well as in public settings. In particular, dogs are one of the most common animals kept as pets worldwide, and often accompany their owners during daily activities. It is important for dog owners to keep or have access to water and food in order to maintain the health and wellbeing of their dog. This can provide difficult in environments where natural water sources are not readily available or in public settings where access to a water bowl can be inconvenient.

### SUMMARY OF THE INVENTION

This summary is provided to introduce a variety of concepts in a simplified form that is further disclosed in the detailed description of the embodiments. This summary is not intended for determining the scope of the claimed subject matter.

A portable cooler for pet supplies is disclosed including a cooler having an insulated housing constructed having an interior reservoir to retain water. A top is removably connected to the insulated housing and constructed as a container to store one or more pet supplies. The portable cooler allows pet owners to easily transport, access and provide water and food to their pets.

The insulated housing of the portable cooler provides a means for insulating water and food products to maintain them at a safe and suitable temperature. Further, the portable cooler is large enough to retain a large amount of food and water which can be readily accessed by the pet throughout the day. This eliminates the need for the owner to find water, food, and a serving vessel to present the water and/or food to their pet. The separate container and reservoir allow for liquids and food products to be stored and served separately from one another.

In one aspect, the top includes a lid to enable the selective opening and closing of the container.

In one aspect, the lid is pivotally attached to the top via a hinge. The hinged movement of the lid allows for the user to easily open and close the top, thus providing efficient access and storage capabilities.

In one aspect, the top is usable as a bowl for serving and consuming food.

In one aspect, the insulated housing includes a handle to facilitate carrying and transport of the cooler.

In one aspect, the insulated housing is comprised of a bottom, a first sidewall, a second sidewall, a third sidewall and a fourth sidewall each integrally molded to form the interior reservoir. Each sidewall and the bottom are constructed to have insulated properties, such as through roto molding, or by other means known in the arts.

In one aspect, a rim is positioned at a top edge of the insulated housing, the rim to fittingly engage with the top. The rim provides a sealed engagement between the top and the insulated housing to maintain the insulative properties of the portable cooler.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the portable cooler for pet supplies, according to some embodiments;

FIG. 2 illustrates a perspective view of the portable cooler for pet supplies wherein the lid is open, according to some embodiments; and

FIG. 3 illustrates a perspective view of the portable cooler for pet supplies wherein the lid is removed to enable access to the interior of the insulated housing of the cooler, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a portable cooler for pet supplies which may be used to easily and efficiently transport pet supplies including food, water, treats, and other items. The cooler includes an insulated housing constructed having an interior reservoir to retain water, food and other items. A top is removably engaged to the insulated housing and can be used as a container for the storage of water, food and/or other pet supplies in a separate compartment from the interior of the insulated housing. In such, the cooler includes at least two interior storage compartments allowing for the separation of items which may be advantageous for separating solids and liquids, or other items.

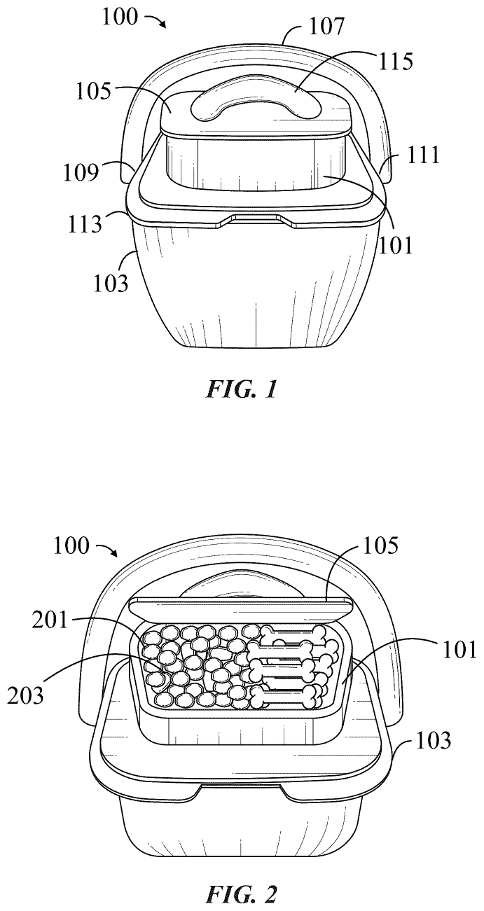

FIG. 1 illustrates the portable cooler 100 in a closed configuration wherein the top 101 is attached to an insulated housing 103. The top 101 includes a lid 105 which is used to enclose the top 101 which stores pet items therein. A first handle 107 is pivotally engaged with the insulated housing 103 to allow the portable cooler 100 to be easily carried. The first handle 107 may pivot from each of a first side 109 and a second side 111 of the exterior 113 of the insulated housing 103. A second handle 115 is positioned on the lid 105 which allows the user to easily open and close the lid 105 as needed as well as to remove the top 105 from the insulated housing 103.

In some embodiments, the insulated housing 103 is used to contain food, water, and other pet supplies therein. Similarly, the top 101 may also enclose food, water, and other pet items in a separate container from the insulated housing 103. This enables the user to separate pet items from one another to avoid cross contamination, avoid water mixing with dry goods, etc.

FIG. 2 illustrates the portable cooler 100 wherein the lid 105 is open while the top 101 remains attached to the insulated housing 103. Opening the lid 105 exposes the contents stored in a container 201 defined by the interior 203 of the top 101, thus enabling the top 101 to be used as a bowl 200 by a pet. The lid 105 may be pivotally engaged with the top 101 to allow its selective opening and closing to expose the contents stored within the container 201. In some embodiments, the lid 105 may be removable from the top 101.

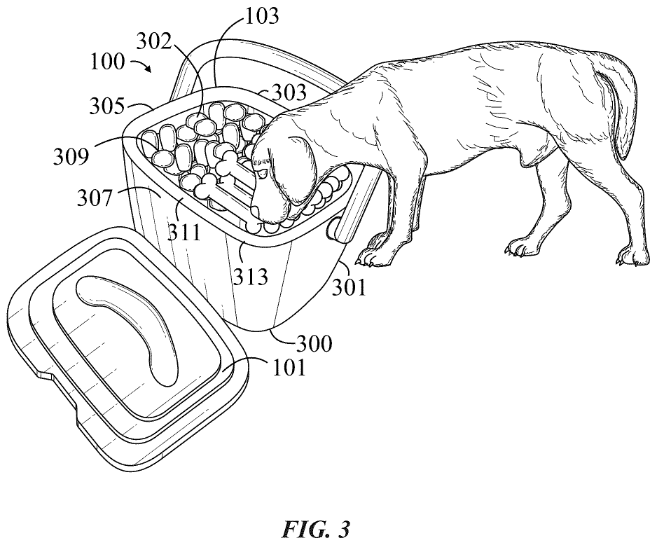

FIG. 3 illustrates the portable cooler 100 wherein the top 101 is removed from the insulated housing 103. The insulated housing 103 includes a bottom 300, a first sidewall 301, a second sidewall 303, a third sidewall 305 and a fourth sidewall 307 which define an interior reservoir 309 which may be used to store water (not illustrated), food 302, and other pet supplies. The insulated housing 103 is useful for keeping liquids and/or foodstuff insulated from the exterior environment, thus keep, for example, water cool throughout the day. This may also be beneficial for keeping food products cold and/or hot, such as to preserve the food products for extended periods of time. A rim 311 is positioned around a top edge 313 of the insulated housing 103 allows for top 101 to be fittingly engaged thereto, thus securing the top 101 to the rim 311 to provide an insulative environment within the portable cooler.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A portable cooler for pet supplies, comprising:
a cooler including an insulated housing constructed having an interior reservoir to retain water; and
a top removably connected to the insulated housing, the top constructed as a container to store one or more pet supplies.

2. The portable cooler for pet supplies of claim 1, wherein the top includes a lid to enable the selective opening and closing of the container.

3. The portable cooler for pet supplies of claim 2, wherein the lid is pivotally attached to the top via a hinge.

4. The portable cooler for pet supplies of claim 1, wherein the top is usable as a bowl for serving and consuming food.

5. The portable cooler for pet supplies of claim 1, wherein the insulated housing includes a handle to facilitate carrying and transport of the cooler.

6. The portable cooler for pet supplies of claim 1, wherein the insulated housing is comprised of a bottom, a first sidewall, a second sidewall, a third sidewall and a fourth sidewall each integrally molded to form the interior reservoir.

7. The portable cooler for pet supplies of claim 6, further comprising a rim positioned at a top edge of the insulated housing, the rim to fittingly engage with the top.

8. A portable cooler for pet supplies, comprising:
a cooler including an insulated housing constructed having an interior reservoir to retain water;
a top removably connected to the insulated housing, the top constructed as a container to store one or more pet supplies;
a lid releasably attached to the top, the lid to enclose the container; and
a first handle pivotally engaged with an exterior of the insulated housing.

9. The portable cooler for pet supplies of claim 8, wherein the interior reservoir is capable of holding a plurality of beverage container and a plurality of food items.

10. The portable cooler for pet supplies of claim 9, further comprising a second handle connected to an upper surface of the top, the second handle to facilitate removal of the top from the insulated housing.

11. The portable cooler for pet supplies of claim 10, wherein the lid is pivotally attached to the top via a hinge.

12. The portable cooler for pet supplies of claim 11, wherein the top is usable as a bowl for serving and consuming food.

13. The portable cooler for pet supplies of claim 12, wherein the insulated housing is comprised of a bottom, a first sidewall, a second sidewall, a third sidewall and a fourth sidewall each integrally molded to form the interior reservoir.

14. The portable cooler for pet supplies of claim 13, further comprising a rim positioned at a top edge of the insulated housing, the rim to fittingly engage with the top.

15. A portable cooler for pet supplies, human beverages, and food, comprising:
a cooler including an insulated housing constructed having an interior reservoir to retain water or a plurality of beverage containers or a plurality of food items;
a top removably connected to the insulated housing, the top constructed as a container to store one or more pet supplies;
a lid releasably attached to the top, the lid to enclose the container; and
a first handle pivotally engaged with an exterior of the insulated housing, the handle to.

16. The portable cooler of claim 15, wherein the insulated reservoir has a rotomolded construction.

17. The portable cooler of claim 16, wherein the cooler is dimensioned to be stored within a basket of a golf cart.

18. The portable cooler of claim 17, further comprising a second handle connected to an upper surface of the top, the second handle to facilitate removal of the top from the insulated housing, wherein opening the lid via the handle facilitates access to the one or more pet supplies stored therein, and wherein the top is usable as a bowl for serving and consuming food.

19. The portable cooler of claim 18, wherein the lid is pivotally attached to the top via a hinge.

20. The portable cooler of claim 19, further comprising a rim positioned at a top edge of the insulated housing, the rim to fittingly engage with the top.
